(19) United States
(12) Patent Application Publication
(10) Pub. No.: US 2014/0278881 A1
(43) Pub. Date: Sep. 18, 2014

(54) Automated Method and System for Coupon Vision and Interpretation With Selective Use of Human Assisted Processing

(71) Applicant: SnipSnap App, LLC, Philadelphia, PA (US)

(72) Inventors: Theodore C. MANN, Haddonfield, NJ (US); Kostas Ilias NASIS, Woodbury, NJ (US)

(73) Assignee: SNIPSNAP APP, LLC, Philadelphia, PA (US)

(21) Appl. No.: 14/202,858

(22) Filed: Mar. 10, 2014

Related U.S. Application Data
(60) Provisional application No. 61/782,481, filed on Mar. 14, 2013.

(51) Int. Cl. G06Q 30/02

(52) U.S. Cl. CPC G06Q 30/0225
USPC 705/14.26

(57) ABSTRACT

A method for interpreting user submitted coupon images is described. A coupon image is received over a network from a user. The coupon image is associated with a coupon. A server system processes the received coupon image to identify one or more coupon matching characteristics. The one or more coupon matching characteristics are compared to historical coupon data stored in a coupon database. Matching coupon data is returned to the user if a coupon matching the one or more coupon matching characteristics is found in the coupon database. The received coupon image is transmitted for human assisted processing if a coupon matching the one or more coupon matching characteristics is not found in the coupon database.

### CROSS-REFERENCE TO RELATED APPLICATIONS

This application claims priority to U.S. Provisional Patent Application No. 61/782,481 filed Mar. 14, 2013, which is incorporated herein by reference.

### BACKGROUND OF THE INVENTION

Discount offers are provided in a variety of physical and virtual shapes and forms, including rebates, coupons, instant savings, and the like. One popular type of discount offer is the coupon. Retail coupons, as shown in FIG. 5A, are often provided as physical coupons in mailers, newspapers, catalogs, and the like. Such coupons are a useful way for consumers to save money, and for marketers to drive awareness of their product, service, or business.

Most businesses process their coupons by scanning a barcode or keying in a promotional code (or the barcode number) into a point-of-sale (POS) system. Businesses such as Target and Kohl's have attempted to supplant the distribution of paper coupons by instead offering pure-play digital alternatives, like email, text messages, and mobile applications. These approaches involve distributing an offer code or barcode as an image to display on screen. Regardless of whether the coupon is paper or digital in origination, displaying an image of the coupon on a screen of a mobile device (e.g., a smartphone, tablet) is usually a sufficient method for the store to honor redemption of the presented coupon.

Manufacturer coupons, as shown in FIG. 5B, are issued by a company that makes a consumer product good. These coupons do not follow the same methods of paper-less redemption. For these types of coupons, which are commonly redeemed at supermarkets and convenience stores, simply presenting the coupon image on a mobile device is not sufficient, as the store needs to have a record of the coupon being used in order to be reimbursed from the manufacturer. Typically, the record is the actual paper coupon presented by a customer during check out. Therefore, for example, if Supermarket XYZ accepts a paper coupon for $1 off cereal, the Supermarket saves this piece of paper as a receivable, which they ultimately remit to the manufacturer to be paid back for the $1 discount they credited or paid to the consumer, plus a small handling fee.

While paper-based redemption of manufacturer coupons is the norm, there are some other digital-based processes which attempt to remove the physical tender from the equation. The most commonly accepted form of paperless redemption of manufacturer coupons involves a consumer saving a virtual coupon or e-coupon and linking it to a store loyalty card. For example, a consumer may “clip” a $1-off coupon on a website, and add their frequent shopper card number to their account. That coupon is then associated with the consumer's loyalty number. The next time the consumer checks out with an item eligible to use the clipped coupon, the coupon is automatically applied at the POS terminal.

Due to the volume of available coupons, their small physical size, and inconvenience of carrying such coupons, as well as a plurality of other reasons, paper and loyalty card linked coupons are difficult for consumers to keep track of. If a consumer does not remember of the availability of the coupon prior to making a purchase, the consumer is usually not able to take advantage of the discount embodied by the coupon. This results in only a miniscule portion of available coupons being redeemed by consumers annually. In fact, while more than three hundred billion manufacturer coupons are issued in paper form each year, and far more are issued by retailers, restaurants and local businesses, less than one percent (1%) of these offers are redeemed.

Accordingly, it is desirable to provide a system for improving consumers' access to coupons. It is further desirable to provide systems and methods that improve the usability of paper coupons by digitizing the paper coupons for access and presentation using consumers' mobile devices.

### BRIEF SUMMARY OF THE INVENTION

In one embodiment, a method for interpreting user submitted coupon images is described. A coupon image is received over a network from a user. The coupon image is associated with a coupon. A server system processes the received coupon image to identify one or more coupon matching characteristics. The one or more coupon matching characteristics are compared to historical coupon data stored in a coupon database. Matching coupon data is returned to the user if a coupon matching the one or more coupon matching characteristics is found in the coupon database. The received coupon image is transmitted for human assisted processing if a coupon matching the one or more coupon matching characteristics is not found in the coupon database.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1A is a system diagram of an exemplary coupon interpretation system in accordance with preferred embodiments of the present invention;

FIG. 1B is a system diagram of an exemplary image handling system for use with the coupon interpretation system of FIG. 1A;

FIG. 2 is a flowchart of steps for scanning and parsing a paper coupon according to preferred embodiments of the present invention;

FIG. 3 is a flowchart of steps for activating Printed Manufacturer Coupons via a Loyalty Card-Linked Offer according to preferred embodiments of the present invention;

FIGS. 4A and 4B are exemplary graphical user interface for human assisted paper coupon digitization; and

FIGS. 5A and 5B are exemplary paper retail and manufacturer coupons for use with the system of the preferred embodiments.

### DETAILED DESCRIPTION OF THE INVENTION

Certain terminology is used in the following description for convenience only and is not limiting. The words “lower,” “bottom,” “top” and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

Preferred embodiments of the present invention relate to methods and systems for interpreting physical and virtual image-based discount offers (e.g., money off, percent off, free items, and the like) regardless of shape, form, format, and the like into structured coupon data. Discount offers requiring interpretation may be photographed, scanned, or otherwise captured (e.g., screenshot) for the purpose of redeeming at a merchant or service provider. Once interpreted, the coupon image and data are preferably stored in a remote storage system such as a database so that the coupons are accessible to the end user regardless of the end user's location or the accessing mobile client 14 (FIG. 1A) used by the end user. The end user accesses the coupon image and coupon data in order to redeem the coupon when completing a transaction.

In the preferred embodiment, the user photographs a physical coupon using a mobile client 14 having a data reading device such as a camera. Even more preferably, the mobile client 14 is a smartphone having an integrated camera. However, the mobile client 14 may be any type of computing device, including both portable and non-portable devices such as laptops, tablets, standalone cameras, and the like. The captured image data is transmitted over a network (e.g., the Internet) to a remote server system. The server system processes the image data and returns a “mobile-optimized” version of the photographed coupon image. Preferably, the mobile optimized version of the coupon includes an easy-to-scan view of the barcode, promotion code, and the digitized coupon image. The end user is able to retrieve the coupon using his or her mobile client 14, without the need to keep the physical copy of the coupon on hand. While in the preferred embodiment, the mobile optimized coupons are stored in a remote coupon database, they may also or alternatively be downloaded to, and stored by, the mobile client 14 in addition to, or instead of, being stored by the remote coupon database.

Once the mobile optimized coupon has been stored, the user can either redeem the coupon via the coupon image (e.g., by presenting the coupon displayed on their mobile client 14 to a cashier, or the like), or the user can link the coupon with a store loyalty card, credit card, or other payment type.

In the preferred embodiment, an application (mobile, web, or the like) executed by the mobile client 14 provides access to the mobile optimized coupons. Preferably, the application tracks coupons that are of interest to the user (e.g., scanned, photographed, and downloaded coupons), and provides the user with notifications regarding those coupons. Notifications may be time based, for example, a notification may be a reminder that a coupon will expire within a predetermined time period, such as within two days. Notifications may also be geography based, such as a reminder to use a saved coupon when the user arrives at a store for which they have coupons saved.

The user redeems a saved coupon, usually by presenting the coupon barcode, promo code, or image at checkout, or else by having the offer applied to their transaction the loyalty card or credit card-linked approach.

Referring to the drawings in detail, wherein like reference numerals indicate like elements throughout, FIG. 1A is a system diagram of an exemplary coupon interpretation system in accordance with preferred embodiments of the present invention. The coupon interpretation system is preferably a client/server based system. One or more mobile clients 14 are communicatively coupled to one or more servers 12 over a network 18. Preferably, the network 18 is the Internet. However, in other embodiments, the network 18 may be any other type of public or private network, such as a cellular network, a Wide Area Network, or the like.

Mobile clients 14 may be any type of computing device, such as a smart phone or tablet computer, having one or more processors, one or more memories, a network interface and a data reading device. The network interface is preferably an 802.11 Wi-Fi network adapter or a cellular radio (e.g., 3G, LTE). Data reading devices may be integrated cameras, bar code readers, and the like. Preferably, the mobile clients 14 are configured to execute a web browser, a web application, and/or a mobile application stored on a memory of the mobile client 14, or provided to the mobile client 14 over the network 18 from the servers 12. The application(s) may be standalone applications configured to perform the processes described herein. Alternatively, the processes may be implemented as one or more functions of an application designed for another purpose. For example, the processes may be employed as a feature within a retail chain's web or mobile application, or as part of a coupon publisher's application. Likewise, the system described herein may also be employed via a web application, desktop computer software, scanner, or other device capable of capturing a coupon image.

The servers 12 are preferably one or more physical servers, virtual servers, or a combination thereof configured to provide a plurality of services to the mobile clients 14. The servers 12 provide Applied Programming Interfaces (APIs) for interacting therewith. In one embodiment, the servers 12 implement an n-tiered server architecture including one or more web servers and one or more application servers, as is known to those skilled in the art. Preferably, the servers 12 are located at one or more remote locations, such as at a data center, or the like.

A plurality of databases 10 are communicatively coupled to the servers 12. In the preferred embodiment, the databases 10 include a coupon database 10a, a geospatial location database 10b, and a analytics database 10c. The databases 10a, 10b, 10c may each be an independent database, or they may be split into separate databases. A messaging subsystem 16 is also communicatively coupled to the servers 12.

FIG. 1B shows a system diagram of an exemplary image interpretation system. Mobile clients 14 transmit an image 50 captured by the data reading device of the mobile client 14 to an image processing server 12a over the network 18 (FIG. 1A). The image processing server 12a receives the images 50, and performs the image interpretation process, described in further detail with respect to FIG. 2. Functions performed by the image processing server 12a include, but are not limited to, barcode detection, optical character recognition (“OCR”), logo detection, operations, thumbnail generation, image resizing, and optimization. A database lookup engine 52 is communicatively coupled to the image interpretation server 12a and an offer engine server 12b, which is also coupled to the mobile clients 14. The offer engine server 12b matches the image data interpreted by the image interpretation server 12a to coupons already stored in the coupon database 10a. If so, the interpreted coupon is returned to the mobile client 14 without further processing being necessary. The offer engine server 12b also provides linking for manufacturer coupons, recommendations and coupon targeting services. An offer network server 12c is communicatively coupled to the engine server 12b. Those skilled in the art will understand that one or more of these functions may be performed by other servers or computing devices, other functions may be modified or omitted entirely without departing from the scope of this invention.

FIG. 2 is a flowchart of steps for image capture and scanning of a coupon. The process begins at step 101 with a coupon (or other offer) to be interpreted. The coupon is most commonly a physical coupon (e.g., a paper coupon), however those skilled in the art will understand that other forms and formats of virtual coupons, such as screenshots and email images of coupons may be submitted for interpretation as well, and are within the scope of this invention.

The coupon is captured at step 102 using a data reading device such as a camera, scanner, or screenshot software of a mobile client 14, or the like. At step 103, a coupon image 50 of the coupon is created. In one embodiment, the coupon image 50 is stored locally on a memory device of the mobile client 14. In this case, at step 104, a scanning process is initiated by the mobile client 14. More preferably, the coupon image 50 is submitted from a mobile client 14 over the network 18 to the server system 12 for processing. At step 104, the scanning process 104 is initiated. In this case, the image processing server 12a performs the scanning process of step 104.

The first step of the scanning process 104 is to apply disqualification heuristics to the coupon image 50. Various criteria may disqualify a coupon image 50 from being considered a coupon. For example, at step 108, it is determined whether the coupon image 50 contains faces and no text, if so, the coupon image is recognized as “not a coupon” at step 108a. Various other criteria for disqualifying coupon images 50 may be applied by the scanning process 104, resulting in the coupon being disqualified at step 108a. Such disqualification heuristics are known to those skilled in the art, and may be applied without departing from the scope of this disclosure.

If the image is not disqualified by any of the heuristics, the scanning process attempts to recognize a known barcode format at step 107. Any type of optical machine-readable representation of data (e.g., one dimensional bar code, two dimensional bar code, and the like) may be recognized at step 107 without departing from the scope of this invention. If a barcode is recognized at step 107, the barcode number and type are checked at step 109 against the historical coupon database 10a by the offer engine server 12b to determine if there is a match to another previously parsed coupon. If there is no match to the barcode recognized at step 107 in the coupon database 10a, the scanning process moves on to step 106 for image recognition. However, if an identical match is found in the coupon database 10a, and the match does not meet any of the exception rules, the new coupon image 50 is saved to the coupon database 10a with the identical structured coupon data at the match step 110. The coupon database 10a then returns the structured coupon data and the coupon details to the end user at step 112. This pairing process is referred to as “Coupon Match.”

If no barcode is detected or no barcode match is found at step 107, at step 106 a scan of the coupon image 50 for known visual signatures is performed. One such visual signature is an overall coupon fingerprint. If the offer engine server 12b recognizes a match to another previously recognized coupon, it will perform the same function as with Coupon Match (i.e. returning the identical structured coupon data along with the new image to the coupon database) at steps 109 and 110.

If an overall match for the visual signature is not made at step 106, the image processing server 12a also attempts to find visual signatures such as store logos, products, barcodes or face values (typically the largest text, displaying the discount or dollars off). Matches for any of these signatures will typically mean that one (1) data type on the coupon has been successfully recognized (e.g. Store name, Product name). This will signify that data for that field has been entered.

Coupon Match

In order to achieve a full coupon match, at least four (4) of the key coupon-data fields (Face Value, Store, Product, Offer Details, Expiration Date, Promo Code) must be identified and match up with a coupon already in the coupon database 10a. The image recognition of step 106 alone may not be sufficient to recognize all of the data fields. In this case, the image recognition step 106 is combined with the Optical Character Recognition (OCR) step 105 in order to make a match to a coupon in the coupon database 10a more likely to be made.

If unsuccessful in matching a coupon to a known, previously saved coupon fingerprint at step 106, scanning continues into the OCR step 105. The image processing server 12a uses an OCR engine such as those offered by ABBYY, NUANCE, and TESSERACT to attempt to identify blocks of alphanumeric text throughout the coupon image 50. In many cases, the coupon image 50 will be blurry or difficult to scan, and the image processing server 12a pre-processes these coupon images 50 with several techniques in order to improve text recognition. These techniques include, but are not limited to, “bleaching” the image into pure black and white, filtering out noise, edge sharpening. Other techniques for improving the OCR ability of an image are known to those skilled in the art, and are within the scope of this disclosure.

Once the text of the coupon image 50 has been recognized, the image processing server 12a attempts to parse it using terminology common to coupons by identifying fields clearly linking the text to a given data-type. For example, if a block of text begins with the term “Expires:” or “Valid Through,” the subsequent text will be interpreted as an expiration date. See the Appendix for a list of terms used in this scanning process, as well as their prescribed mapping.

If the OCR process of step 105 successfully interprets text for one or more of the coupon data fields, the system checks to see if any other data from the coupon has been successfully mapped (via image recognition of step 106 or OCR of step 105). If four (4) or more fields are complete for a given coupon image 50, the offer engine server 12b checks the coupon database 10a to see if there is another coupon in the coupon database 10a with identical data at step 109. For example, if image recognition sees a logo for TOYS “R” US (Store field) and a value of 20% Off (Face Value field), and OCR interprets an Expires: 1/1/2013 (Expiration Date field) and a product of “PLAYSKOOL ROCKTIVITY TABLE” (Product field), and all of these data exist for a coupon previously saved in the coupon database 10a, the offer engine server 12b would recognize a Coupon Match at step 110. If no match is made at step 109, the fields interpreted via image recognition step 106 and the OCR step 105 are deemed to the be key coupon data for a new coupon record.

If a coupon has failed to achieve Coupon Match through any of the above qualifications—barcode matching, coupon-image fingerprint matching, or pairing four or more fields parsed from OCR/image recognition, the system next attempts to process the coupon via human labor at step 113. A worker is directed to a form displaying the coupon image 50 and asked to manually transcribe all of the coupon-data fields. A crowd labor system such as AMAZON MECHANICAL TURK can be used to perform this task. Preferably, a form including the fields to be transcribed is provided to the worker. Accuracy and reliability of the human labor process of step 113 is improved by providing fields with auto-complete features, calendar based date-pickers, and the like.

As shown in FIGS. 4A and 4B, the form also asks the worker to crop and rotate the coupon image (if necessary) and to identify the key visual signatures of the coupon store logo, product image, barcode and face value by either drawing a boundary on a desktop computer (FIG. 4A), or circling it with their finger on a touch-based device (FIG. 4B). This feedback allows the image processing server 12a to capture thumbnail images of the store, product, or face value. Further, it trains the image processing server 12a to identify various logos and images, thus aiding in the image-recognition phase of step 106. In another embodiment, the end user that provided the coupon image 50 is asked to identify the same signatures—store logos, product images, barcodes, and face values—of the coupon image 50 within a touch-based application or game. The results of the human labor process of step 113 are stored at step 115 in the coupon database 10a.

After a sufficient number of coupon images 50 have been identified by human labor at step 113, the image processing server 12a is able to automatically recognize commonly reproduced coupon layouts. Using the type of iterative algorithm described in European Patent No. 2390822A2, which is also U.S. Pat. No. 8,340,363 (Sarkar et al.), the entire disclosures of which are both incorporated herein by reference, the image processing server 12a models the location and spatial relationship of the categorized logos, products, barcodes and face-value images in order to determine the overall structure of the coupon, and better aid in Coupon Match.

Redemption

Once a coupon has been scanned and parsed, it is presented to the end user in the form of a mobile coupon that can be redeemed in a store or other facility. Preferably, at step 116, the end user activates a redeem mode, or screen, of a mobile application executed by his or her mobile client 14 in order to display the coupon barcode, promo code, or coupon image 50 in whatever form is most appropriate for the type of store or other facility the end user is visiting. The form to be displayed depends on store policy, with some stores utilizing barcodes for redemption, while others only needing to see the coupon image 50. Preferably, the end user can easily switch between the available coupon display modes using a graphical user interface of the mobile application executed by the mobile client 14.

At step 117, the offer engine server 12b solicits feedback from the end user post-redemption, asking if the coupon worked or not. Other types of feedback may also be solicited without departing from the scope of this invention. This feedback is aggregated across the user base to create overall success ratings for stores and coupons, helping other users to know which retailers are most accepting of mobile client 14 based coupon redemption. Furthermore, recommendations and coupon targeting may be performed by the offer engine server 12b based on coupons used by the respective end users, and their feedback.

### Digital Receivable

In addition to extracting structured coupon data from the captured image, the system recognizes the image itself as a receivable, or valid record of the coupon. In the event that a coupon issuer requests proof of the original coupon's existence, this digital image can be furnished to the coupon issuer.

Further, the system attempts to compare any new image against the record of previously submitted images to determine that the latest image is unique. While the coupon within the photograph itself may be one that has been scanned hundreds of times before, the image itself should not be identical. If it is recognized as such, the coupon will be deemed a duplicate—which may or may not be permissible given the terms and conditions of the offer.

### “Scan at Home”—Card-Linked Offers & Manufacturer Coupons

In some cases, an interpreted coupon may be linked to a loyalty card or the like at step 118. FIG. 3 is a flowchart of steps by which a coupon can be linked to a loyalty card (or credit card), a secondary process termed “Scan at Home”. This is most commonly the case for coupons which are recognized to be manufacturer coupons, or coupons issued for products and intended to be redeemed at grocery stores, mass merchandisers, drug stores, or convenience stores.

For these types of coupons, historically the stores have saved the paper copies of coupons in order to remit them to the manufacturers to get reimbursed. In most of the industry, stores handle this reimbursement process through third-party clearinghouses that validate and settle all of the claims. Some clearinghouses, such as industry-leader INMAR, have also developed or acquired systems for digital couponing. Unlike the print process, these systems utilize the loyalty programs developed by grocery stores in order to “link” an offer code to a consumer's loyalty account. Once linked, these digital coupons are automatically applied at the Point of Sale (POS) when a consumer checks out.

The “Scan at Home” enables a printed coupon to be cleared and settled, and then activated as a digital offer linked to a consumer's loyalty card. After a user scans a manufacturer coupon, the user is prompted to link it to their loyalty card, after which the coupon will be instantly transacted when the user purchases the product (and swipes or scans their loyalty card).

When a coupon completes the scanning progress (104-114), if the image processing server 12a identifies the phrase “Manufacturer's Coupon” (or one of several variations of this) or the presence of a manufacturer coupon barcode (either GS1 databar or other code already in the system), the coupon will be identified in the coupon database 10a and designated for linking to a loyalty card at step 201.

At step 202, the user is prompted to select at which store (preferably from an available stores list) they would like to redeem the offer. The offer engine server 12b checks to verify if the user has previously stored a loyalty number at step 203 and, if so, it looks up that number at step 204. If a loyalty number has not been stored, the user is prompted to enter their store loyalty number or scan in their loyalty card at step 205. The offer code, loyalty number, store name, and coupon image are then transmitted at step 206 to an offer network/clearinghouse server 12c. The offer network/clearinghouse server 12c is preferably operated by a third party, such as INMAR. The offer network server 12c processes the received data at step 207.

The offer network server 12c looks up the print offer code to verify if there is a corresponding digital offer at step 208. If one exists, the digital offer code is associated with the user's loyalty number at step 209, and both of these data are transmitted by the offer network server 12c to a supermarket loyalty system (not shown) at step 214. At this point, the offer is considered to be active and awaiting purchase in the loyalty program CRM at step 215. Once an end user buys the product and presents their loyalty card/number at checkout, the discount is made at the POS terminal and displayed on their receipt at step 216. Consequently, at step 217 the offer is deactivated, and this information is relayed back from the loyalty program to the offer network server 12c to the offer engine server 12b, ultimately displaying an alert or message to the end user on the end user's mobile client 14 that the coupon has been successfully redeemed and deactivated.

In the event that no digital offer exists at step 208, a request is made by the offer network server 12c to generate an offer at step 210. This step requires that the manufacturer who originated the offer has approved this form of paperless redemption. The determination whether the offer is pre-approved for paperless redemption is made at step 211. If the offer has not been pre-approved, then the offer is considered “invalid” at step 212. If it is approved, then a new offer is created, and returned to the system at step 213.

### APPENDIX

### Sample Coupon Parsing Rules

### I. Manufacturer Coupon

1. Look for identifier string in top quarter of coupon beginning with one of the following phrases: “Manufacturer's Coupon,” “Manufacturer Coupon,” “Mfr Coupon”
2. If greater than 80% match in characters to above phrase and rectangular square box detected at top of coupon, return a result of “Manufacturer Coupon”

### II. Store Name

1. Look for presence of known store logo, and if matched return that result for Store Name field.

### III. Product Name

1. Look for presence of known product logo.
2. If product is name is recognized elsewhere in coupon text, return the text in Product Name field.

### IV. Face Value

1. Identify largest 10 rows of text on coupon image.
2. Look for identifier string beginning with the following phrases: “Save,” “Up to,” “Get,” “Free” and followed by alphanumeric string in the same font size, return this as Face Value field.
3. If identifier string ends with “Off,” “Free,” “Value” and begins with alphanumeric string of the same font size, return this in the Face Value field.

### V. Promo Code

1. Look for identifier string beginning “code,” “promotional,” “PLU”
2. Enter alphanumeric sequence following identifier string in to Promo Code field.

### VI. Expiration Date

1. Look for identifier string beginning with “Expires,” “Valid,” “Valid Through,” “Through,” “Thru”
2. If Manufacturer Coupon identifier string detected, look for expiration-date string immediately adjoining
3. Search for strings matching date formats in this order:
   a. MM/DD/YYYY
   b. Month DD, YYYY
   c. MMM DD, YYYY
   d. DD MMM YYYY
   e. DD Month YYYY

### VII. Start Date

1. Look for identifier string beginning with “From,” or followed by “Through” or “Thru.”
2. Search for strings matching the same date formats as above.

### END OF APPENDIX

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for interpreting user submitted coupon images, the method comprising:
receiving, by a server system, over a network, a coupon image associated with a coupon from a user;
processing, by the server system, the received coupon image to identify one or more coupon matching characteristics;
comparing, by the server system, the identified one or more coupon matching characteristics to historical coupon data stored in a coupon database;
returning, over the network, matching coupon data to the user if a coupon matching the one or more coupon matching characteristics is found in the coupon database; and
transmitting the received coupon image for human assisted processing if a coupon matching the one or more coupon matching characteristics is not found in the coupon database.

2. The method of claim 1, wherein the processing further comprises determining by the server system whether the coupon image is a coupon based on one or more disqualification criteria.

3. The method of claim 2, wherein the processing further comprises performing by the server system at least one of barcode recognition, image recognition, and optical character recognition on the receiving coupon image.

4. The method of claim 1, further comprising determining by the server system that the coupon represented by the coupon image is a manufacturer's coupon.

5. The method of claim 4, further comprising:
transmitting, over the network, a request to the user to link the coupon represented by the received coupon image to a loyalty card;
receiving, from the user, a linking identifier to be associated with the coupon; and
transmitting the coupon and the linking identifier to a third party offer clearinghouse.

6. The method of claim 5, wherein the linking identifier is a retailer name and a loyalty rewards number associated with the user.

7. An apparatus that interprets user submitted coupon images, the apparatus comprising:
(a) a network; and
(b) a server system that receives, over the network, a coupon image associated with a coupon from a user, the server system:
(i) processing the received coupon image to identify one or more coupon matching characteristics, and
(ii) comparing the identified one or more coupon matching characteristics to historical coupon data stored in a coupon database;
(iii) returning, over the network, matching coupon data to the user if a coupon matching the one or more coupon matching characteristics is found in the coupon database; and
(iv) transmitting the received coupon image for human assisted processing if a coupon matching the one or more coupon matching characteristics is not found in the coupon database.

8. The apparatus of claim 7, wherein the processing further comprises determining by the server system whether the coupon image is a coupon based on one or more disqualification criteria.

9. The apparatus of claim 8, wherein the processing further comprises performing by the server system at least one of barcode recognition, image recognition, and optical character recognition on the receiving coupon image.

10. The apparatus of claim 7, further comprising determining by the server system that the coupon represented by the coupon image is a manufacturer's coupon.

11. The apparatus of claim 10, wherein the server system further:
(v) transmits, over the network, a request to the user to link the coupon represented by the received coupon image to a loyalty card;
(vi) receives, from the user, a linking identifier to be associated with the coupon; and
(vii) transmits the coupon and the linking identifier to a third party offer clearinghouse.

12. The apparatus of claim 11, wherein the linking identifier is a retailer name and a loyalty rewards number associated with the user.
